(19) United States
(12) Patent Application Publication
(10) Pub. No.: US 2011/0131108 A1
(43) Pub. Date: Jun. 2, 2011

(54) Internet Loyalty and Rewards System

(75) Inventor: Brian Doxey, Champaign, IL (US)

(73) Assignee: Quarles & Brady LLP, Madison, WI (US)

(21) Appl. No.: 12/899,869

(22) Filed: Oct. 7, 2010

Related U.S. Application Data
(60) Provisional application No. 61/265,429, filed on Dec. 1, 2009.

(51) Int. Cl. G06Q 30/00

(52) U.S. Cl. 705/26.1; 705/1.1

(57) ABSTRACT

A rewards system for use in a networked environment in which information is transmitted to a central rewards server via a segregated flow of information from the member computer and an affiliate server. The affiliate sends details of a member's transaction via a structured network request. The generated network request includes affiliate information, action information, a time stamp, and a hash code. Member information is supplied directly from the member to the central rewards server. In this way, the reward server, not the affiliate, has access to information about the member. Members may browse the affiliates and accumulate points in the system for actions taken at any of the affiliates. The central reward server allows members to redeem points accumulated from various affiliate servers in an aggregate manner. Members redeem points for goods, gift certificates, or access to third-party content directly from the reward server.

### CROSS-REFERENCE TO RELATED APPLICATIONS

This application claims priority to co-pending U.S. Provisional Application No. 61/265,429, filed on Dec. 1, 2009, which is entirely incorporated herein by reference.

### STATEMENT REGARDING FEDERALLY SPONSORED RESEARCH OR DEVELOPMENT

Not applicable.

### BACKGROUND OF THE INVENTION

The present invention relates generally to networks and specifically to a system for managing and monitoring end user activity between two or more computer systems and rewarding the end user for activities performed at one of the systems.

Systems for rewarding customers and end users for behavior are well known. In such systems, a reward provider must have two types of information: (1) identification of the rewards participant; and (2) the action for which rewards are earned.

For example, airlines, credit card issuers, and other companies offer various types of loyalty programs. These loyalty programs operate in a linear fashion. At one end, there is a rewards program operator. At the other end, there is a rewards program participant. In between, there is any number of intermediaries. The intermediary can be the point of interaction with a rewards participant, such as a participating business or the point-of-sale system. In the traditional loyalty program, the program operator rewards participants with points or miles for engaging in certain activities such as shopping at a participating location, charging purchases to a specific credit card, or buying airline tickets through a specific airline. In the linear case, a participant earns points by first identifying themselves at the time of a reward-earning transaction. Identification can take the form of a username, account number, credit card, or other unique or semi-unique form of identification. Second, the details of the rewards-earning transaction, along with the participant's identification, are passed back to the loyalty program operator by way of the participating business or point-of-sale system. Depending on the type of rewards program and the number of intermediaries, among other things, this process can take a number of days. And if the linear process is disrupted at any point, the loyalty program operator has no way of knowing how to calculate the points earned or to whom the points should be awarded.

Linear loyalty programs are well suited to situations in which identification is mandatory, such as paying for goods or purchasing airline tickets. The traditional, linear model, however, cannot efficiently be applied to internet activities, such as browsing, searching, and commenting, in general. It is impractical to require participants to actively identify themselves with each visit to disparate, unrelated websites. A participant may browse many dozen sites each day and many such actions can be done anonymously or without any authentication at the hosting website. In addition, the linear model would require that the identification information of the participant must be sent along the chain in multiple steps and through multiple intermediaries creating additional points of failure, as well as security and privacy concerns.

Another type of reward system is structured as a rebate program. In a rebate program, there is a rebate provider, an affiliate website, and a participant. The participant is required to register with the rebate provider. To invoke the rebate program, the participant follows links provided by the rebate provider through the rebate provider's website. A code embedded in the link indicates that the visitor is a participant to the affiliate. The participant then must engage the affiliate in a transaction. This involves providing additional information, including registering with the affiliate, that is separate from the participant's rebate provider account. The participant completes a transaction at regular price, and the affiliate notifies the rebate provider of the transaction. The rebate provider then forwards any applicable rebate to the participant. The CASHBACK program is therefore link-driven: participants earn rebates at the affiliates only if they arrive at the affiliate's website via the link from the rebate provider within a specified amount of time.

Like linear loyalty programs, rebate programs are not well-suited for internet activities, in general. The short life of every link means that normal activities, like browsing, would have to be periodically interrupted with trips back to the rebate provider to regenerate a new code. Extending the lifetime of the links means that the rebate systems can be easily defrauded by sharing the link with other members or even parties outside of the system, undermining the rebate provider's ability to keep track of anything. In addition, the links are directed to specific affiliate websites, while internet browsing is frequently not directed at a single website. In order to obtain the benefit of the rewards system a participant would also need to return to the rebate provider's site to visit additional websites. Further, such systems require that the participants have accounts at all points: with the rebate provider, with the merchant, and with a financial institution in order to receive the rebate. In order for a system to reward day-to-day internet actions efficiently, it must be able to do so automatically and without the interruption required by creating multiple accounts.

Further, rebate programs suffer the same issues raised by the linear model described above. Participant-identifying information is passed on by the rebate provider to the merchant, who adds the transaction information, then passes it all back. The multiple-step process can result in loss or delay of data and impinge on the participant's privacy or security.

Other systems have been devised to track participant behavior at partner websites, for instance, FACEBOOK BEACON. In those systems, information is transferred from the partner site to the tracking service by tracking information about visitors, including internet protocol (IP) addresses, regardless of whether the visitor was a participant of the tracking service. If the visitor was a participant of the tracking service, information from these visits was used by the tracking service. In the case of FACEBOOK, for example, information about behavior on the partner site was published on the user's “newsfeed,” where it could be seen by the user's friends and others. Such tracking services suffer from serious privacy and security problems.

The present invention combines a variety of techniques in a new, novel way to overcome these issues. The present invention tallies points for standard internet activities and does not publicly publish any information. The present invention does not store information regarding the content of any of the participant's activities. Further, the present invention does not need to transmit or store any information concerning non-participants, although it may. In the present invention, the affiliate does not need detailed information in order to award its visitors points. The present invention also does not require the exchange of personal data across various websites. The present invention is also not tied to the completion of actions requiring the affiliate to acquire information about a participant, such as viewing ads, purchasing products, or signing up for services.

The present invention maximizes privacy and security by retrieving the details of member actions by using a segregated model. The details of an action come directly from the affiliate whereas the member-identifying information is retrieved from the member. By using this segregated method, the present invention ensures that an affiliate never knows the identity of the visitor by virtue of a visitor's enrollment in the rewards system. In addition, the affiliate may never know whether the particular visitor is even a member of the rewards system. Further, members are unable to access specific identifying details from the affiliate that would allow them to cheat the system in favor of themselves or anyone else.

Finally, the challenges described above have made online, action-based rewards systems impractical. Current technological limitations provide unique challenges to the integrity and seamlessness of online rewards systems. The present invention overcomes the technological and non-technological challenges.

### BRIEF SUMMARY OF THE INVENTION

In one embodiment of the present invention, a rewards network server for use in a rewards system comprising at least one affiliate system and at least one member computer, comprises a database system with at least one member record, the member record comprising a member identification, a date, and a point count and at least one affiliate record, the affiliate record comprising an affiliate identification, an action identification, a point count, and an affiliate hash key. The computer server programmed to receive a network request for a resource from the member computer, receive a member identifier from the member computer; retrieve an affiliate record from the database system associated with the affiliate identification token and the action identification token; compute a system hash from the affiliate hash key in the affiliate record and the time stamp token; and compare the system hash to the hash code token. If the system hash and the hash code token match, the point count from the affiliate record associated with the affiliate identification token and action identification token may be added to the point count in the member record associated with the member identifier. The network request comprising an affiliate identification token, an action identification token, a time stamp token, and a hash code token.

In another embodiment, the database system further comprises at least one affiliate account record, the affiliate account record comprising an affiliate identification and a point balance. The at least one computer server may be further programmed to, upon adding the point count from the affiliate record to the member record associated with the member identifier, subtract the point count from the point balance associated with the affiliate identification token.

In another embodiment, the affiliate record further comprises a point maximum, the point maximum may be selected from the group consisting of: a maximum number of points that may be awarded in a time period; a maximum number of points that may be awarded to a member computer; and a maximum number of points that may be awarded for an action identification.

In another embodiment, the action identification may be associated with a reward action, the reward action may be selected from the group consisting of: a webpage request, a search request, a completion of a commercial transaction, a subscription to a newsletter or mailing list, a purchase of access to premium content, a registration with a website or forum, and a click-through of an advertisement. Furthermore, each reward action may be associated with a different point count in the database system.

In another embodiment, the computer server may be further programmed to transmit an acknowledgement to the member computer. The acknowledgement may be selected from the group consisting of: a display of the points awarded associated with the action token, a display of the point count in the member record associated with the member identifier, and a display of no points award if the system hash and hash code token did not match. The acknowledgement may be further transmitted as the resource responsive to the network request. The acknowledgement may also be a transparent image or not visible to the member. In one case, the network request may be a request for an image. In another case, the network request may be a request for a webpage. The network request may be received as an FTP, HTTP, or HTTPS request.

In one embodiment, the hash code token may a hash of the time stamp and the affiliate hash key. The affiliate hash key may be assigned by the reward system. The hash code may further expire after a period of time. And the period of time may be less than one minute.

In a further embodiment of the present invention, the computer server may be further programmed to: (i) offer the member computer a list of rewards items, wherein each of the rewards items may be associated with a value specified in points; (ii) deduct the value specified in points for a selected reward item from the point count in the member record associated with the member identifier upon receipt of selection of the selected rewards item by the member computer; and (ii) transmit an order for the selected rewards item to be shipped to a member associated with the member computer. The list of rewards items may be selected from the group consisting of: a tangible good; access to premium or restricted content; a service; and a gift certificate. In addition, the list of rewards items may include goods or services from the at least one affiliate system. The list of rewards items may also include goods or services from at least one unaffiliated vendor. Further, the computer server may be further programmed to accept payment from the member for a selected rewards item and wherein the payment may be in addition to deducting the value specified in points.

In addition, the computer server may be further programmed to charge an affiliate for the point count in the affiliate record; wherein the charge corresponds to the point count multiplied by an exchange rate for money-for-points set by the rewards system. The charge may be performed when the associated affiliate record is created. The charge may also be performed when the associated point count nears zero. Further, the charge may be performed upon adding the point count to a member record. Or, the charge may be performed at the request of the affiliate system associated with the affiliate record. In another embodiment, the charge may be a subscription charge and the exchange rate is unlimited points for the subscription charge during a period of time.

In a further embodiment of the present invention, the computer server receives the member identifier from a cookie stored on the member computer. The computer server may be further programmed to store the cookie on the member computer.

In another embodiment, the at least one affiliate system cannot determine the member identifier associated with a member computer. And, in another, the affiliate system is not the rewards network server.

In one embodiment, the system rewards members for their actions at affiliate websites, such as viewing web pages, posting in internet discussion forums, or making purchases. Members are automatically awarded points, tallied centrally by a central hub. The points are redeemed for rewards. The rewards may include merchandise, gift certificates for services, or complimentary access to paid content on various websites.

In one embodiment, an affiliate website pre-buys or is allocated a certain number of points. The system sets the points aside in a segregated account to be awarded to members for engaging in certain actions on the affiliate's website. The system awards a certain number of points to each member for each action. In one embodiment, the system specifies the number of points per action. In an alternative embodiment, the affiliate may specify the number of points per action. In addition, the system, or the affiliate, may specify a maximum number of points any member can earn during a specified period of time. In an alternative embodiment, the system or an affiliate may specify the maximum number of points in total that may be earned in a day by all members. Once the affiliate's point reserves are depleted, members will no longer be able to earn points for their actions on the affiliate's site until the reserve is replenished. The system or the affiliate may replenish the points.

In order to award points to members, the system receives two types of information: (i) the identity of the member; and (ii) the details of the action for which the member is being rewarded. In one embodiment of the present invention, the system segregates the sources of these two types of information. In another embodiment, the system collects member information from the member himself or herself, and collects the action details from the affiliate. When a visitor to an affiliate performs a specific action on the affiliate website, the computer code on the affiliate's sites connect to the system. The code identifies the affiliate site to the system using a variety encrypted and unencrypted variables.

In some embodiments, when the system receives the action from the affiliate, it checks whether the visitor is a member. In one embodiment, the system checks for the existence and validity of a persistent cookie set on every members' computer when the member logs into the System. The cookie contains encrypted data identifying the visitor as a member of the system.

In some embodiments, the system validates both the action details provided by the affiliate and the member information obtained from the visitor using a validation procedure. If both components are valid, the system credits the member with the stipulated number of points. In one embodiment, the system will log the points earned and basic information about the action, such as the time and date of the action and the identity of the affiliate. After the member logs into the system, the point-earning process is automatic to the member; the member need not take any further action with the system to earn points. Similarly, the member need not identify himself or herself as a member of the system to the affiliate in order to accumulate points at the affiliate.

In another embodiment, the system will tally all points earned by its members. Members may have the ability to access their own point totals and action history at any time through a webpage on the system. This information is not published without the member's explicit permission, nor is it available from any affiliate website.

In yet another embodiment, the system maintains an inventory of rewards that may be distributed to members. Rewards may be purchased by the system operators for use within the system or provided by advertisers, sponsors or affiliates. System operators may set the cost for each reward. The cost is calculated in number of “points.” Different rewards may have different costs.

In still another embodiment, when a member earns enough points to claim a reward, the member purchases the reward through the system. The system processes the request and validates the request. The validation may occur automatically. In an alternative embodiment, the system may permit manual validation. The validation may include a review of internet protocol address and audit or review of the number of points from referring affiliates. The system then deducts the cost of the reward from the member's points and delivers the reward to the member or schedules the reward for delivery at a later date.

These and other features, objects, and advantages of the present invention will become better understood from the description that follows. The description of preferred embodiments is not intended to limit the invention or to cover all modifications, equivalents and alternatives. Reference should therefore be made to the claims herein for interpreting the scope of the invention.

### BRIEF DESCRIPTION OF THE DRAWINGS

FIG. 1 is a diagram showing one arrangement of a network involving the system, one affiliate and one member.

FIG. 2 is a flowchart illustrating one embodiment of the process from the viewpoint of a member.

FIG. 3 is a flowchart illustrating one embodiment of the process from the viewpoint of an affiliate.

FIG. 4 is a chart showing the flow of information from the affiliate and member to the system.

FIG. 5 is a flow chart illustrating one embodiment of the rewards redemption process.

FIG. 6 is an example uniform resource locator that is included at an affiliate's website.

FIG. 7 is a high level overview of entities and relationships in an exemplary embodiment of a database for use in the system and method of the present invention.

### DETAILED DESCRIPTION OF THE INVENTION

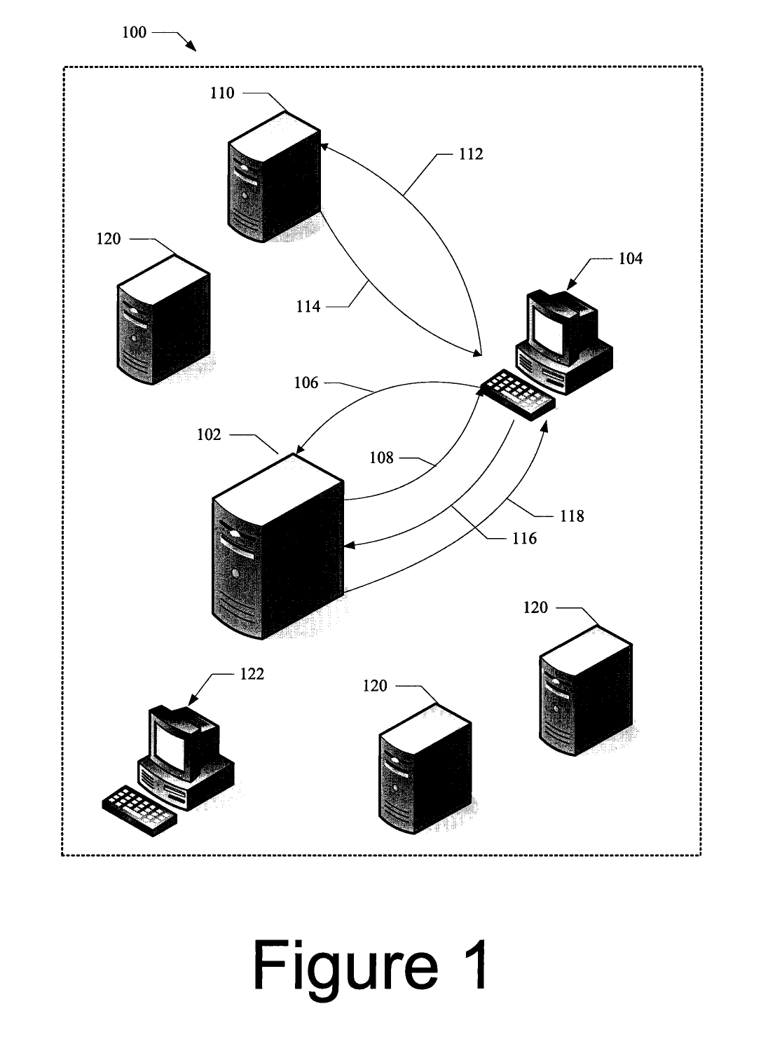

FIG. 1 is a simplified diagram showing one arrangement of a network 100. The network 100 comprises a network-enabled computing device including network server system 102, an affiliate server 110, and a member computer 104. The network may include other computers, hubs, cell phones, mobile devices, laptops, network-enabled devices, tablets, or computer systems, such as servers 120. Servers 120 may or may not be an affiliate of the system. Similarly, network 100 may include one or more other visitors 122. Visitors 122 may or may not be participants in the system. Network 100 may be the internet or another public network that allows for communication between two or more devices. It will be readily apparent to one of ordinary skill in the art that the present invention could be implemented on various networking protocols or various network arrangements such as LANs, WANs, virtual private networks, etc.

The network server system 102 may be a network server. The network server system 102 is connected to the network 100 using generally accepted network technology. For example, the network server system 102 may be capable of communicating using HTTP, FTP, HTTPS, and other similar networking protocols. In one embodiment, the network server system 102 is running a publicly-accessible web server connected to a database system (not shown). The network server system 102 will typically include one or more computer processors, hard drive, memory unit, and networking device. The network server system 102 could be a cluster of computer systems, a rack of computer servers, a distributed collection of computers, or other arrangement of a group of computer systems. The network server system 102 may also be implemented in a geographically-distributed manner. The network server system 102 may also contain a database management system or have a network connection to a database server. The database server itself could be one or more computers. The network server system 102 alternatively could be connected via a network connection, such as an intranet, to a database server that stores and manages the database management system.

The member computer 104 is a computer system connected to the network 100 using standard using standard network technology. The member computer 104 is running standard internet software including an internet browser such as INTERNET EXPLORER, MOZILLA FIREFOX, APPLE SAFARI or other internet browsers that will be known to one of ordinary skill in the art. The computer system will typically include a memory unit, processor, hard drive, input devices (such as a mouse, keyboard, touch-screen, or similar device), and a display device. The computer system may also be a network-enabled device such as a personal digital assistant, RESEARCH IN MOTION BLACKBERRY, APPLE IPHONE, AMAZON KINDLE, smart phone, network appliance, or other similar device. While member computer 104 is shown as a single computer, it is anticipated that a single member could use more than one computer or more than one device (e.g., smartphone) to connect to the network 100.

Like network server system 102, the affiliate server 110 is a network server. The affiliate server 110 is connected to the network 100 using standard network technology, including HTTP, HTTPS, or other similar networking protocols. Affiliate server 110 is typically a provider of online services such as an online retailer, an online publication, or other ecommerce business. Affiliate server 110 will typically run a publicly-accessible web server. Affiliate server 110 may have authentication or other form of online registration know to those of ordinary skill in the art.

With respect to network 100, the following is a brief description of the simplified process used in one embodiment of the present invention. First, the member computer 104 connects to the network server system 102, shown by network request 106. If member computer 104 is new, member computer 104 may be required to register with the system 100. In this case, network request 106 may be requested to supply system 100 with information to enroll with network server system 102. Such information may include name, address, e-mail address, and other information that the network server system 102 may be required from the user of member computer 104 in order to fulfill reward redemption, as discussed below. If the user of member computer 104 has previously registered with system 100, network request 106 may represent member computer 104 logging into network server system 102. Member computer 104 may be required to log into the system 100 if, for example, member computer 104 is a different computer than originally used to log into system 100, the system cache (not shown) of member computer 104 is deleted, or member computer 104 is using a different web browser than was originally used to register with network server system 102. After member computer 104 successfully registers with, or logs into, network server system 102, then network server system 102 will set a persistent cookie (not shown) on member computer 104 by way of network transmission 108. This persistent cookie is stored on member computer 104. The persistent cookie is retained by member computer 104 until the persistent cookie is deleted or removed. After the persistent cookie is set on member computer 104, member computer 104 is able to browse the network 100.

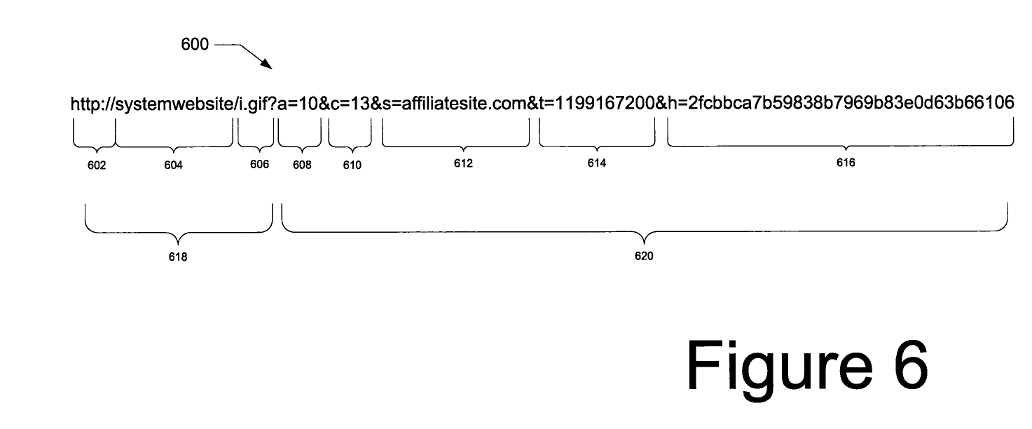

Action 112 is a communication request transmitted by member computer 104 to affiliate server 110. Affiliate server 110 has previously engaged network server system 102, not shown. During the engagement process, affiliate server 110 specified that action 112 is a reward qualifying act. In one embodiment, action 112 may be an HTTP request to affiliate server 110 for content (not shown) stored at, hosted by, or otherwise provided by affiliate server 110. The content may be an image, a webpage, a video, or other form of electronic content. This content is typically embodied in a HTML file (not shown). The HTML file can be static or dynamically created using a scripting language such as PHP, .NET, ASP, COLDFUSION or other scripting language known to one of ordinary skill in the art. In another embodiment, action 112 may be a secure post to affiliate server 110 necessary to complete a purchase of goods from affiliate server 110. In another embodiment, action 112 may be a search request to affiliate server 110. In another embodiment, action 112 may be posting (or submitting) a story, article or comment to a forum, newsgroup, weblog (blog), or chat room. In response to action 112, affiliate server 110 sends information 114 back to member computer 104. In one embodiment, information 114 is an HTML file (not shown) having a generated URL 600 (as shown in FIG. 6), described below. In one embodiment, the generated URL 600 contains a network address controlled by network server system 102. In addition to the generated URL 600, information 114 is typically responsive to the action 112. For instance, information 114 may also include the requested content (such as an image, webpage, or video), a receipt indicating completion of the purchase of goods, or a listing of search results.

In network 100, member computer 104 is responsible for accessing the generated URL 600. This is shown by network request 116. In one embodiment, network request 116 is an HTTP request for an image located at the generated URL 600. Upon receiving network request 116, the system 100 will use the information transmitted to credit member computer 104 for the action, as described in greater detail below. And, among other things, network server system 102 may optionally respond by returning acknowledgement 118. Acknowledgement 118 may be the requested image. In this embodiment, the image may be a 1×1, transparent GIF. In another embodiment, the image may be a count of the number of rewards points. In another embodiment, the image may be the logo or other image associated with the system. The image may be the logo or other indicator of the network server system 102, it may also be an image from the affiliate server 110. The acknowledgement 118 may also include information such as the number of points awarded, the total number of points of a member computer 104, the total points of a member computer 104 earned at the affiliate server 110, information regarding the number of points awarded to every member at affiliate server 110, or some combination of the foregoing. The acknowledgement 118 may further include information relevant to member computer 104's browsing history or interest such as recommendations for related sites or similar advertisements.

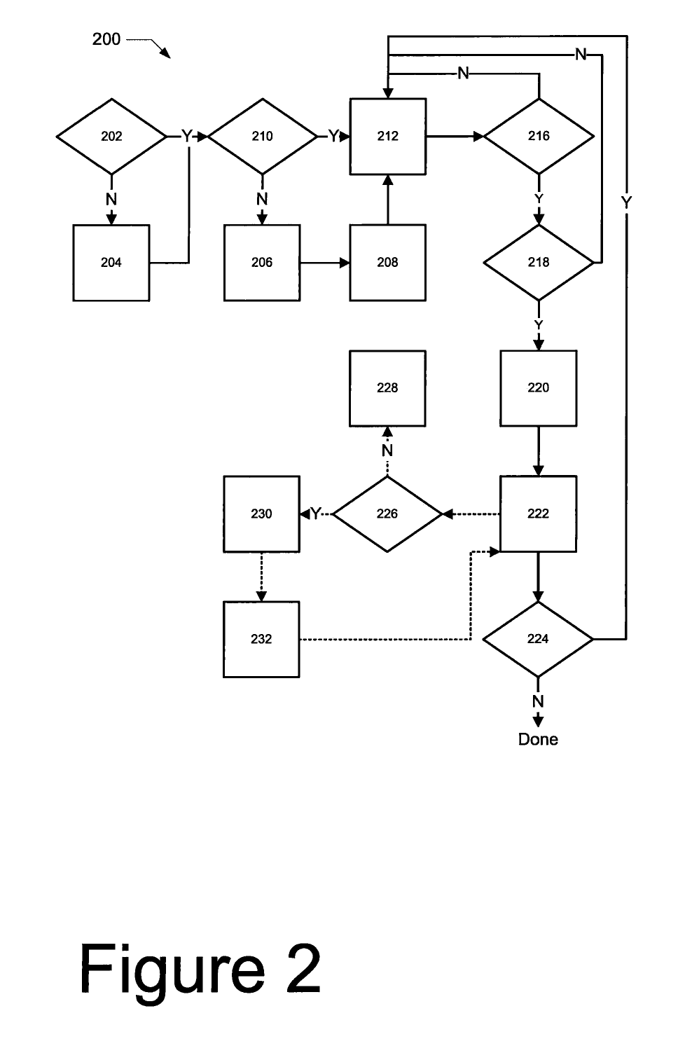

FIG. 2 is flowchart illustrating the rewards process 200 as viewed by member computer 104 within network 100. When member computer 104 first joins network 100, member computer 104 becomes part of network server system 102 in order to be awarded points. Accordingly, at decision 202, if member computer 104 has not registered with network server system 102, member computer 104 can register. Following the “no” path to registration step 204, the member performs the registration process with network server system 102. As described above, the registration step 204 may involve receiving information form member computer 104 as necessary to enroll with network server system 102. The process may involve a number of steps (not shown) including providing a valid electronic mail address, billing information, address, name, username, password, or other information necessary to effectively administer the rewards system. Network server system 102 may respond with confirmation.

Once registered, member computer 104 may “log into” the network server system 102. In the illustrated embodiment, there are two paths to log in step 206. First, if member computer 104 has registered for the first time via registration step 204, then network server system 102 may optionally require that member computer 104 utilize the newly acquired account information at the log in step 206. Second, if a member had previously registered, the member computer 104 can remain logged into network server system 102 in order to be awarded points. Decision 210 asks whether a member is logged in. If a member computer 104 is not logged in, member computer 104 follows the “no” path to the login step 206, otherwise member follows the “yes” path to the network browsing step 212. A member computer 104 may not be “logged into” network server system 102 if, for example, member computer 104 is using a different computer than was used to register or the persistent cookies were deleted or lost. If member computer 104 is not logged in, then the member can perform the log in process at login step 206. In one embodiment, member computer 104 can log into network server system 102 by visiting network server system 102 and supplying a username or password. In another embodiment, member computer 104 may log in using a toolbar or other integrated application that can be part of the internet or network browsing software used by member computer 104. In the latter case, the appropriate login information is sent from the browser to network server system 102 without having to navigate to the network server system 102 site. In either case, network server system 102 cane authenticate the login information with its members database. If the information process continues to the authenticated member step 208, if not, then the login process may be repeated.

At the authenticated member step 208, a persistent cookie or other similar persistent data storage is activated or set on member computer 104. The persistent cookie allows network server system 102 to set certain identification information on member computer 104 that can remain both accessible to network server system 102 during network calls from member computer 104 to network server system 102 (such as along network requests 106 and 116 in FIG. 1). The information stored in the cookie can include a user identifier. In addition, the information in the cookie may be encrypted.

Once a cookie has been set, the process flows to network browsing step 212. At network browsing box 212, member computer 104 is free to browse network 100 in his or her normal manner. In one embodiment, network 100 is the internet, and member computer 104 browses the internet using a web browser, as described above. In this embodiment, member computer 104 browses the internet by following hypertext links, submitting forms such as search engines, clicking predefined hyperlinks saved to the web browser, or typing in an address of a website into an address bar. In each case, member computer 104 performs an “action,” such as action 112 in FIG. 1, which requests a network resource, such as affiliate server 110 in FIG. 1, or some other non-affiliated network resource (not shown).

In one embodiment, each time member computer 104 performs a new action, the process proceeds to decision 216. Decision 216 asks whether the requested network resource is an affiliate, such as affiliate server 110 (FIG. 1). If the network resource is not an affiliate, the rewards process ends and the process is returned immediately to network browsing step 212 along the “no” path. However, if the network resource is an affiliate, the rewards process 200 continues along the “yes” path to decision 218.

Decision 218 asks whether the action is a reward action. As described in greater detail below, affiliate server 110 decides which actions are reward actions. In one embodiment, affiliate server 110 may award points for following links to advertisers. In another embodiment, a reward action may be viewing certain content such as videos, images or articles. In another embodiment, a reward action may be performing network searches. In another embodiment, a reward action may be the completion of an e-commerce transaction such as completing a purchase. In another embodiment, affiliate server 110 may award points for subscribing to a newsletter, e-mail mailing list, or RSS news feed. In another embodiment, a reward action may combine any variation of possible actions such as searching for a product and following a link to an advertiser. If the action is not a rewards action, then the rewards process 200 ends and the process proceeds along the “no” path to network browsing 212. However, if the action is a rewards action, process 200 proceeds along the “yes” path to box 220.

If the action was a rewards action, affiliate server 110 can transmit information to member computer 104 at box 220. The information may include a generated URL 600 (shown in FIG. 6). The generated URL 600 references the network server system 102. In one embodiment, the information can take the form of a web page, and the generated URL 600 can be embedded within the webpage as a link to an image. In another embodiment, the generated URL 600 may be a link to a ADOBE FLASH object. In another embodiment, the generated URL 600 may be part of a client-side script, such as JAVASCRIPT. In another embodiment, the information may be an ADOBE FLASH object. In this embodiment, the ADOBE FLASH object can contain the generated URL 600. In another embodiment, the generated URL 600 may be passed directly to a toolbar or other widget of the network browser. In each case, the generated URL 600 is passed back to member computer 104.

After member computer 104 receives the generated URL 600, rewards process 200 proceeds to box 222. At box 222, at least two things can occur. First, member computer 104 can request the resource located at the generated URL 600. This is indicated by the dashed line toward decision 226. This request can occur automatically without additional end user processing. In the case the generated URL 600 is an image, member computer 104 requests the image at the generated URL 600. In the case that the generated URL 600 is embedded in a client-side script or ADOBE FLASH object, the network browser executes the client-side script or ADOBE FLASH object that is responsible for requesting the resource.

At decision 226, network server system 102 validates the generated URL 600. The validation step is described in greater detail below. If the generated URL 600 is not valid, the process 200 proceeds to the no rewards step 228 along the “no” path and no points are awarded to member computer 104's account. Network server system 102 may optionally notify member computer 104 that no points were awarded (this step is not shown). If the generated URL 600 is valid, the process 200 proceeds along the “yes” path to reward credit step 230. At reward credit step 230, network server system 102 credits member computer 104's reward account with the number of points due for that action. The process then proceeds to acknowledgement step 232 in which network server system 102 may optionally form and return an acknowledgement, such as acknowledgement 118, to member computer 104. This acknowledgement is presented to member computer 104 at box 222. Decision 226, and boxes 228, 230 and 232 may be performed at network server system 102 and the actions are transparent to member computer 104 until the receipt of the acknowledgement, if any acknowledgement is transmitted.

Returning to box 222, member computer 104 is also presented with the result of reward action. In one embodiment, the result is typically a webpage. The webpage may contain a receipt of an e-commerce transaction, the content of a news story, image, video, or a listing of search result. In one embodiment, the webpage can include a place to show an acknowledgement, such as acknowledgment 118, from network server system 102. After box 222, the reward process 200 continues to decision 224. Decision 224 asks whether member computer 104 continues to browse the network. If member computer 104 continues, the reward process 200 can be repeated by following the “yes” path from decision 224 to block 212.

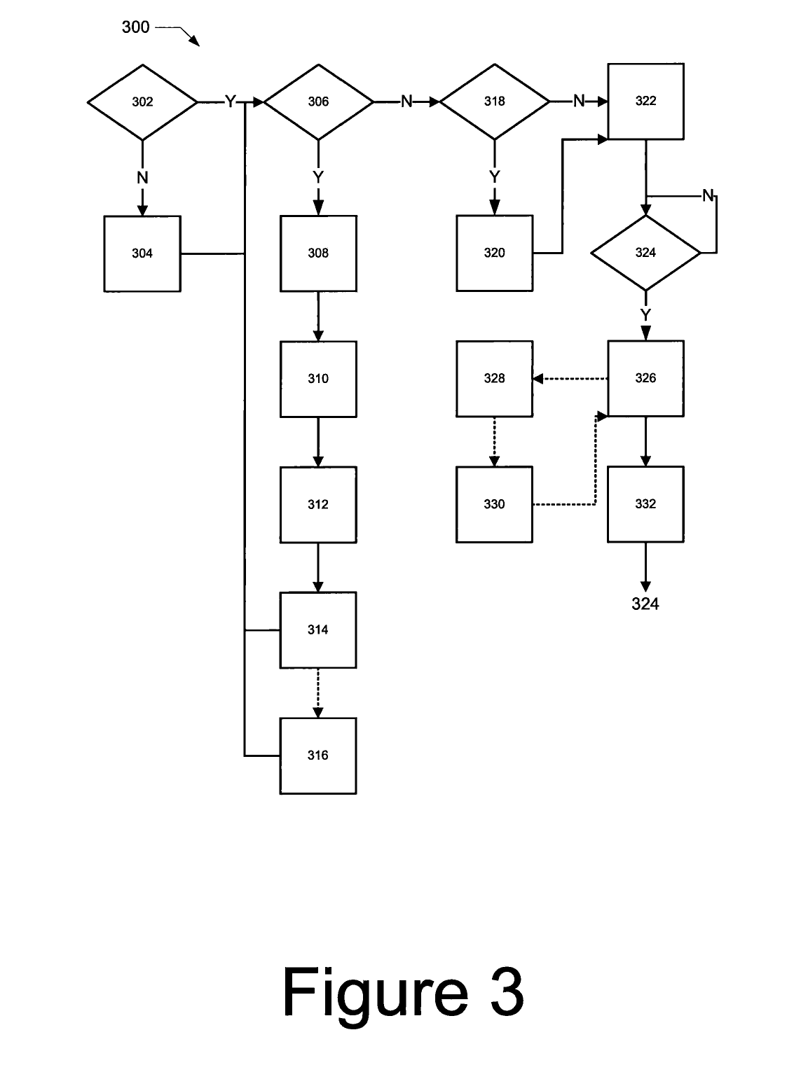

FIG. 3 illustrates an exemplary process of an affiliate, such as affiliate server 110, in rewards network 100. Beginning at decision 302, decision 302 asks whether affiliate server 110 is registered with the rewards network server system 102. Affiliate server 110 may not be registered, for instance, if affiliate server 110 is new to the rewards network 100 and has not previously engaged network server system 102. If an affiliate server 110 is not registered, the process 300 continues along the “no” path to box 304.

At box 304, an affiliate registers with network server system 102. The registration process involves creating an affiliate account with network server system 102. The affiliate account may include login information such as username and password as well as information such as the network address of affiliate server 110, billing information, address and contact information, and e-mail address. The registration process might also include providing a funding source such as a credit card, bank account or similar payment method with which to fund the activities of affiliate server 110 in the rewards network 100.

If affiliate server 110 was previously registered, or once the registration process is complete, process 300 continues to decision 306. Decision 306 asks whether affiliate server 110 needs to create an offer. An offer is a reward exchanged for performance of a reward action. Affiliate server 110 controls the types of offers. Offer creation is performed by affiliate server 110 at the network server system 102. An affiliate may need to create an offer if, for example, the affiliate server 110 has not previously created an offer or affiliate server 110 decides to add a new reward action to the rewards network 100. If affiliate server 110 needs to create an offer, progress through process 300 continues along the “yes” path to block 308. Block 308 permits the affiliate server 110 to create a new offer. In one embodiment, the offer creation process occurs at network server system 102 after affiliate server 110 has registered with, and logged into, network server system 102.

The creation process includes specifying a reward action, box 310. As discussed earlier, the reward action may be viewing specific content, performing an internet search, completing an e-commerce transaction, posting to a forum or posting a comment, signing up for a mailing list, or any number of other network actions. The creation process then determines the value of a particular action, box 312. In one embodiment, fast and frequent rewards actions, such as viewing specific content, may have a low value per action whereas certain actions that are infrequent and more profitable for affiliate server 110, such as signing up for a newsletter or completing a purchase, can have a higher value. Based on the value determined for a specific action, a specified number of points are assigned to that reward action, box 314. In one embodiment, the network server system 102 may determine the value of the reward action. In another embodiment, the affiliate server 110 may determine the value of the reward action. The reward creation process may optionally include specifying a maximum number of points that can be awarded for that reward action, box 316. In one embodiment, the maximum number of points can be on a per member basis thereby limiting the number of points a member can acquire from a specific affiliate for a specific reward action. In another embodiment, the maximum number of points can be time limited thereby limiting the number of points to any members during a specific time period. For example, affiliate server 110 may determine that no more than 10,000 points are to be awarded for viewing an image in any one day. In another example, an affiliate server 110 may determine that no more than 1,000 points are to be awarded to any single member for reading content from affiliate server 110. Once offer creation is complete, process 300 can return to decision 306 to determine whether another offer needs to be created. Affiliate server 110 can have one or more offers active at any given time.

After the affiliate server 110 creates its one or more offers, progress in process 300 continues to decision 318. Decision 318 asks whether any of the offers need additional funding. In the typical embodiment, before an affiliate server 110 can award points for an offer, affiliate server 110 can purchase the points from network server system 102. If affiliate server 110 needs to fund an offer, in this embodiment, process 300 continues along the “yes” path to box 320. At box 320, affiliate server 110 selects the number of points to purchase. Network server system 102 then multiplies the number of points by an exchange rate. The exchange rate is the cost, typically in dollars or cents, for a single point. In one embodiment, the exchange rate to purchase points is fixed across all affiliates. In another embodiment, the exchange rate can be varied based on the affiliate. In another embodiment, the exchange rate may vary depending on the volume of points purchased. The volume of points purchased can be the historical total or merely the present total.

In another embodiment, network server system 102 may optionally allow affiliate server 110 to award points for actions and charges the affiliate server 110 for the points awarded to members 104. For instance, network server system 102 may automatically charge a credit card at the end of each business day an amount equal to the exchange rate for a point in dollars multiplied by the number of points awarded during that day. In another embodiment, network server system 102 may bill affiliate server 110 on a regular basis an amount equal to the exchange rate for a point in dollars multiplied by the number of points awarded during the billing period. In yet another embodiment, affiliate server 110 may pay a flat subscription fee for an unlimited number of award points during the period of the subscription. The period of the subscription might be, for example a week, month, or year. In this embodiment, the subscription may be available to affiliate server 110 for all or a subset of the reward actions. In another embodiment, the subscription may be available to any affiliate server 110 or to only a subset of all affiliates 110. The fee for a subscription may be adjusted based on the historical or anticipated number of reward actions to be generated.

In one embodiment, the exchange rate the network server system 102 charges an affiliate server 110 for each award point may vary depending on the type of award action, exclusivity of the action, or the category of award action. For example, if affiliate server 110 desires to exclusively in search reward actions, such as search, travel or news, network server system 102 may charge affiliate server 110 a higher rate as a flat fee.

Once an offer is funded, progress in process 300 continues to box 322. At box 322, affiliate server 110 is provided with an affiliate-specific, action-specific affiliate code. The affiliate code is used to create the generated URL 600 (shown in FIG. 6 and discussed in greater detail below). The affiliate code may also include a hash key and a hash function. The hash function is a cryptographic function designed to take a string of arbitrary length and produce a hash value. The hash key is a secret string stored within the affiliate code and stored in a database on network server system 102. The hash key acts as a type of password for the hash function. In one embodiment, the hash function takes a timestamp, such as token 614 (shown in FIG. 6), and the hash key generates a fixed length hash token, such as token 616 (shown in FIG. 6). The affiliate code can use any one or more of the number of the hash functions that are known to those of ordinary skill in the art. For example, the hash function could be HAVAL, MD2, MD4, MD5, PANAMA, RadioGatún, RIPEMD, SHA-0, SHA-1, SHA-256, SHA-512, TIGER, or WHIRLPOOL. In an alternative embodiment, the hash token may truncate or crop the length of the result of the hash function so that the length of the hash key is an appropriate size for use in a network request.

In one embodiment, the affiliate server 110 then includes the affiliate code in those resources connected with the reward action. In one embodiment, the affiliate code is included in the server-side script responsible for generating the reward actions and providing the member computer 104 with the corresponding content. This server-side script could be responsible for retrieving the content associated with a reward action from a database; it could be the server-side script responsible for generating a receipt associated with reward action for completing a purchase; it could be incorporated in the server-side script responsible for generating search results associated with the reward action. In another embodiment, the affiliate code may be placed directly into the content, such as an ADOBE FLASH application or client-side script. In any case, once incorporated into the appropriate location, process 300 proceeds to decision 324.

Decision 324 asks whether a visitor (i.e., either member computer 104 or other non-member computer) has performed a reward action. If the visitor has not performed a reward action, process 300 returns to decision 324 along the “no” path and awaits the arrival of a new visitor. However, if the visitor does perform a reward action, process 300 continues along the “yes” path to box 326. In one embodiment, affiliate server 110 may not know whether a particular visitor is a member of network server system 102. In addition, even if the visitor is a member of network server system 102, affiliate server 110 may not know whether the visitor is logged into network server system 102.

At box 326, in one embodiment, affiliate server 110 executes the affiliate code and creates the generated URL 600 in a form shown in FIG. 6. First, affiliate server 110 generates a time stamp, token 614, of generated URL 600 that can reflect the then-current time at which the reward action was requested by the visitor, box 328. Similarly, the action identification number, token 610, of the generated URL 600 can be set to reflect the reward action requested. Finally, a hash token is generated and appended to the generated URL 600, box 330. In one embodiment, the hash token, token 616, can be equal to the calculated result of the hash function using the hash key and the time stamp, token 614. In some embodiments, it may be necessary to crop or truncate the hash token to a specified length. In this embodiment, the generated URL is incorporated into the information returned to the visitor, box 332. The process 300 may then proceed back to decision 324 to await another visitor.

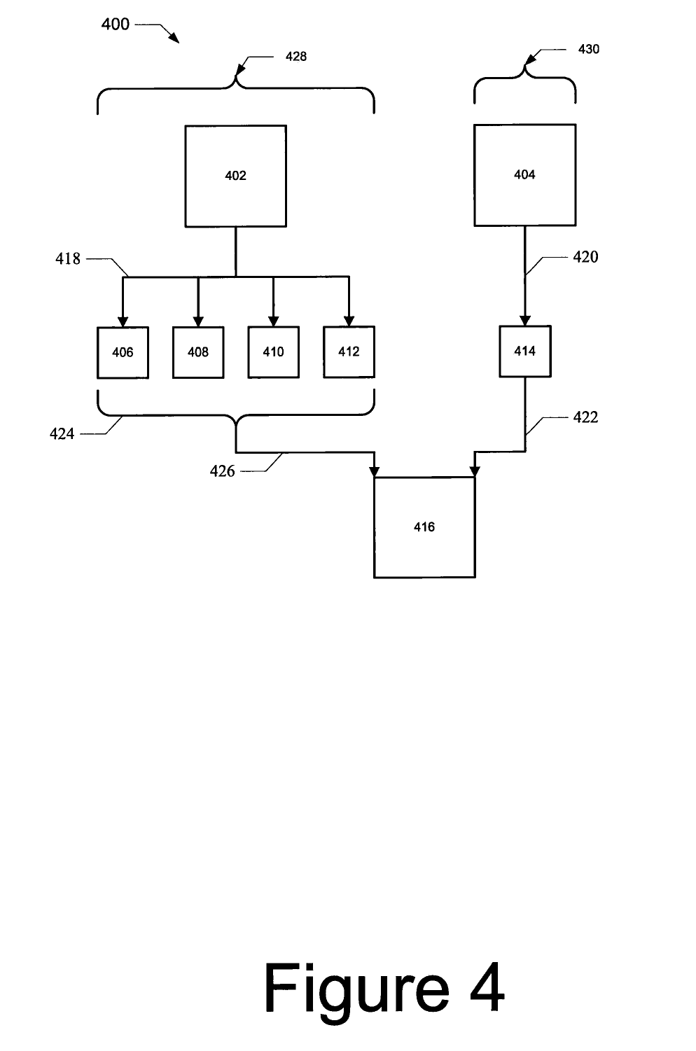

FIG. 4 is an exemplary illustration of the flow of information from member computer 104 and affiliate server 110 to network server system 102 in a network 100 in a segregated system 400. The segregated system 400 has two different information flows: affiliate information flow 428 and member information flow 430. Affiliate information 402 includes the information that affiliate server 110 needs to conduct business with both the member computer 104 and the network server system 102. Member information 404 includes information known to a member computer 104, including information sufficient to identify member computer 104 to network server system 102. System information 416 includes information necessary for network server system 102 to complete a rewards transaction, manage rewards, issue rewards, and accept or debit payment for points.

For use in the rewards network 100, a subset of the affiliate information 402 is formed into a generated URL 600. This is shown by path 418. Information 406 is the affiliate identification number (e.g., token 608 FIG. 6) taken from affiliate information 402. Similarly, information 408 is the time stamp (e.g., token 614 FIG. 6) determined by affiliate server 110. Other affiliate information 410 may include the affiliate server location (e.g., token 612 FIG. 6) and reward action identification number (e.g., token 614 FIG. 6). The affiliate information 402 can also be used to compute a hash token (e.g., token 616 FIG. 6) based on the time stamp and the hash key provided to affiliate server 110 when an offer was created (see, e.g., decision 306 FIG. 3). In the typical embodiment, this information is collected into a single message 424 and sent to network server system 102 for storage within system information 416. This is shown by path 426.

In the typical embodiment, path 426 actually passes through member computer 104. This is shown in FIG. 1 as the route from affiliate server 110 to member computer 104 to network server system 102 via information 114 and network request 116. However, as implemented in a typical embodiment this path is transparent to member computer 104 and is a function of the technique of passing the generated URL 600 to member computer 104. In the typical embodiment, for information within message 424 (e.g., generated URL 600) that is not encrypted such as information 406, 408 and 410, member computer 104 could obtain this information by reviewing the acknowledgement information transmitted by affiliate server 110 to member after a reward action. However, such information is of little value without the information contained in the encrypted portions of message 424, such as information 412 (e.g., the hashed token, token 616 FIG. 6).

Network server system 102 only needs a small subset of the member information 404. Indeed, in the typical embodiment, network server system 102 needs only the same information for every reward action: the member identification information 414. In one embodiment, the member identification information 414 is made available to network server system 102 for use in system information 416 by way of a persistent cookie, path 422. The persistent cookie was set on member computer 104 during the registration or login process, see box 208 of FIG. 2 and network transmission 108 of FIG. 1. The persistent cookie is made accessible from member information 404 its network browsing tools, such as its web browser, along path 420. Unlike the message 426, information 414 is generally not accessible in any manner to affiliate server 110 or available to the affiliate information 402. In this way, member information 404 is unknowable by affiliate server 110 thereby improving the security and privacy of member computer 104. In the case that either message 424 or member information 414 is not accessible or transmitted to the system information 416, the rewards process may terminate and no points awarded to member computer 104 or deducted from affiliate server 110's points.

In another embodiment, network server system 102 may collect or log certain data about its members (not shown). Such data may include member's demographics, geographic location, and browsing history. The network server system 102 may also retain anonymized data regarding which affiliates were visited, how frequently, and what sorts of reward actions members accessed. This data may be used to adjust the pricing of rewards actions or suggest new or different affiliate systems to members.

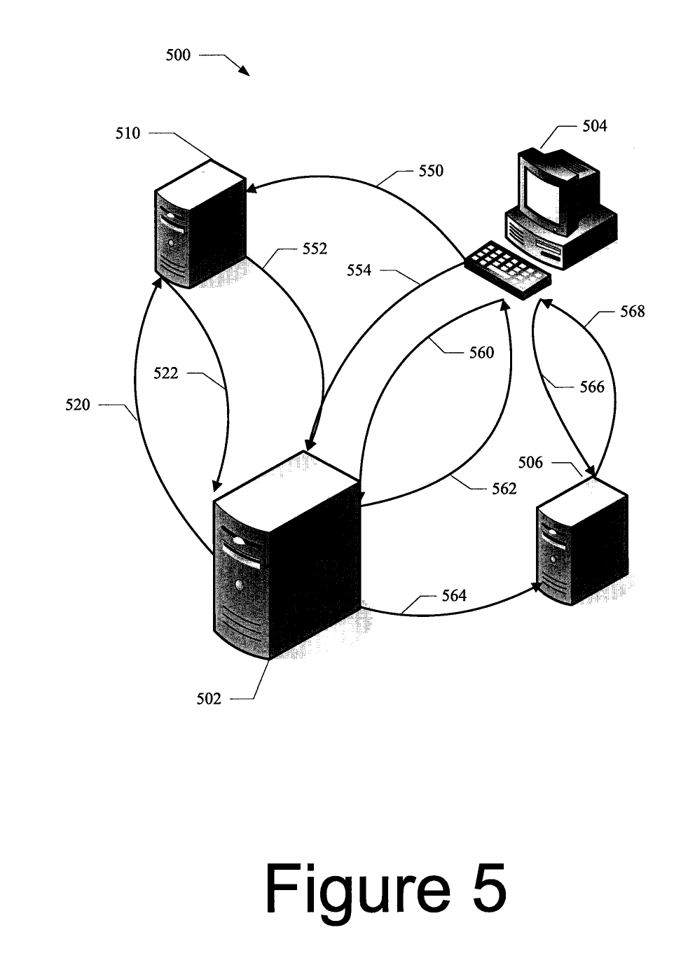

FIG. 5 is a depiction of the points-to-rewards exchange process. In one embodiment, points are a fungible medium of exchange. Briefly, network 500 has a member 504, an affiliate 510, a system 502, and a reward provider 506. Network 500 shows an exemplary process involving purchasing points for dollars, performing actions for points, and redeeming points for rewards. A member 504 may use points from any affiliate 510 to redeem for any reward offered by system 502, no matter the source of either the points or the reward. In the typical embodiment, points are redeemed via system 502 for products, goods, services, or content from a different entity, such as reward provider 506, than the source of the points. In another embodiment, affiliate 510 could be the same entity as rewards provider 506. In the typical embodiment, points come from one or more affiliates 510. And the number of points awarded to a member 504 is stored and maintained by the system 502.

In one embodiment, the affiliate 510 purchases points. This involves a transaction 522 in which affiliate 510 purchases a certain number of points in exchange for a certain number of dollars. As described above, the exchange rate for dollars for points is set by the rewards network 510 at the time of, or before, transaction 522 occurs. The number of points purchased are added to the points account stored on system 502 for affiliate 510. In the typical embodiment, points are purchased for each different type of rewards action, as described in greater detail above. In this embodiment, system 502 is responsible for awarding the points. System 502 may optionally send an acknowledgement or other receipt to affiliate 510 regarding the purchase of points, as shown by path 520.

When member 504 registered with system 502 (not shown in FIG. 5), system 502 created a points account. The points account may be a database stored on system 502. The points account can track valid actions reported to network server system 102 for member 504. In one embodiment, the rewards account may simply be a tally of points. In another embodiment, the rewards account may store detailed transaction information including time, date, source and type of action. The paths of 550, 552 and 554 illustrate one path for collecting points.

By way of example, path 550 is the request for a reward action. After receiving the reward action from member 504, affiliate 504 creates a generated URL 600 (in the exemplary form of FIG. 6) that includes all the necessary information to establish a reward action. This information flows to system 502 via path 552, as described in greater detail above. In addition, the member identifying information is sent from member 504 via path 554. In the typical embodiment, this information is accessible via a persistent cookie stored on member 504. Using the information from both paths 552 and 554, system 502 validates the information and member identification and awards the correct number of points to member 504's points account.

In general a single rewards action may not be sufficient to generate enough points to acquire any specific reward. In the typical embodiment, member 504 may complete a number of rewards actions to accumulate enough points in member 504's points account. In one embodiment, member 504 may purchase additional points directly from system 502 without performing any additional rewards actions. Points purchased directly from system 502 are typically subject to an exchange rate determined by system 502. In one embodiment, this exchange rate may be the same as the exchange rate for affiliate 510. In another embodiment, the exchange rate may be variable.

Once member 504 has accumulated a sufficient number of points, member 504 may redeem the points for a reward. In one embodiment, system 104 may purchase rewards from the proceeds generated from affiliate 510's purchase of points. In another embodiment, a reward provided by advertisers or sponsors of network server system 102. In another embodiment, a reward may provide access to premium content owned and managed by affiliate 510. In any case, system 502 may purchase or gain access to the reward at the time or prior to transferring the reward to member 504. In the example shown in FIG. 5, system 502 has gained access to premium content supplied by reward provider 506. For instance, these rewards could be access to pay-for-view content like news stories, stock quotes, images, videos, or other access-restricted content.

In rewards network 500, member 504 has acquired enough points to earn a reward at the reward provider 506. Member 504 exchanges his or her points for the reward, as shown by path 560. System 502 deducts the necessary points from member 504's points account. In the embodiment shown, system 502 then notifies member 504 via path 562 of the information necessary to access reward provider's restricted content. In addition, system 502 notifies reward provider 564 of the information necessary to establish member 504's access via path 564. Member 504 is then able to access the reward by visiting reward provider 506 via path 566. Reward provider 506 provides the access-restricted content via path 568.

Other simpler rewards are contemplated for this network 500. For example, if member 504 redeemed points for a tangible good, such as games, music, books, or electronics, system 502 could simply deduct the points from member 504's points account and have the good shipped. In one embodiment, these goods could be shipped directly by system 502 or provided by a third party. In another embodiment, points may be redeemable for gift certificates. As with goods, such gift certificates may be delivered directly from system 502 or from a third party reward provider.

In one embodiment of rewards network 500, a reward redemption request via path 560 may be validated or audited by system 502. The validation or audit may be performed manually or automatically using known fraud detection techniques. In one embodiment, the system 502 can review the member 504's points account and check whether a disproportionate number of points were earned quickly and whether the points were redeemed from a high number of different internet protocol addresses. In both cases, such activity is indicative of potential abuse or fraud and a redemption request may be flagged as suspicious. If a transaction is flagged as suspicious, a manual review of the reward redemption may be necessary.

FIG. 6 is an exemplary version of a generated URL 600. A URL is a uniform resource locator. The generated URL 600 is comprised of two main parts: the system address indicator 618 and the query string 620. The system address indicator 618 typically contains a protocol 602, a hostname 604, and a path 606. In other embodiments, the generated URL 600 may also optionally include a username (not shown), password (not shown), port number (not shown), or any combination thereof. In FIG. 6, the protocol 602 indicates that the generated URL 600 is dereferenced using a standard HTTP protocol. In other embodiments, the protocol 602 can be any suitable protocol understood by one of ordinary skill in the art including HTTPS (secure HTTP) or FTP. The hostname 604 is the address of network server system 102 or of another site or server under the control of network server system 102. In one embodiment, the hostname is the website of network server system 102. In another embodiment, the hostname is a server dedicated to receiving network requests 116. In one embodiment, the hostname 604 is a registered domain name. In another embodiment, the hostname 604 may be a static IP (internet protocol) address. In another embodiment, the hostname 604 may be an IPv6 address. Other embodiments will be appreciated by those of ordinary skill in the art.

The path 606 provides or makes accessible the location of a resource on a server. In this example, the path 606 is the location of an image file, “i.gif” A GIF file is typically a static image file. In the exemplary embodiment, however, the i.gif file is capable of executing a server-side script. The server-side script could be written in PHP, .NET, COLDFUSION, ASP, PERL, JAVA or other suitable programming language or combinations thereof. One purpose of the server-side script is to read the values included in the query string 620, perform the validation process (described below) and, if valid, credit a member for the action. In another embodiment, the path 606 could be a connection to the location of an HTML page or other similar resource.

The query string 620 is comprised of tokens 608, 610, 612, 614, and 616. In this embodiment, the tokens 608, 610, 612, 614, and 616 are in the format, variable name=value, and are separated by ampersands. The exemplary embodiment does not require any special order of the tokens 608, 610, 612, 614, and 616. The first token 608 is an affiliate identification number. The affiliate identification number is typically a unique value assigned to each affiliate server 110. The affiliate identification number may also be a unique value assigned to each account registered by affiliate server 110. In the latter case, an affiliate server 110 may have more than one affiliate identification. The second token 610 is an action identification number. The action identification number is a unique identifier associated with a particular offer. The action identification number is generated when an offer is created, as described in FIG. 3, at boxes 308-316. In one embodiment, the action identification number is unique among all affiliates. In another embodiment, the action identification number is unique only for a particular affiliate server 110. As described above, each affiliate server 110 may have more than one different offer and therefore may have more than one action identification number.

The third token 612 is the address of affiliate server 110. As shown in FIG. 6, token 612 is the domain name of affiliate server 110. In another embodiment, token 612 could be the IP address of affiliate server 110. In another embodiment, token 612 could include both an address as well as a path.

The fourth token 614 is a time stamp. The time stamp is a machine-readable numerical representation of the exact time at which the action was performed. In one embodiment, the time stamp is a count of milliseconds. In another embodiment, the time stamp is a count of seconds. In another embodiment, the time stamp is a concatenated string that includes month, day, year, hour, minute and second. In the typical embodiment, the format of the time stamp may be determined by the network server system 102 and a valid time stamp created by the affiliate server 110 can use that format. In operation, by definition, the time stamp will be different for every action.

The final token, token 616, is a hashed token. A hashed token is created with each unique action by encrypting the time stamp (token 614) with a unique hash key assigned by network server system 102 for the affiliate identified by the affiliate identification number (token 608) for action identified by the action identification number (token 610). As described above, the hash key is known by network server system 102 and by affiliate server 110. The hashed token (token 616) allows network server system 102 to validate the generated URL 600, as described above. In addition, since the time stamp (token 614) is used in computing the hashed token, the hashed token (token 616) is time sensitive. Network server system 102 can specify a duration in which any single token is valid. For instance, if network server system 102 determines that a hashed token is valid for only 1 minute from the time in the time stamp, the hash token (token 616) will not be valid after one minute from the time specified in the time stamp. However, since the time stamp is used to compute the hashed token, tampering with the timestamp will not extend the duration. In another embodiment, network server system 102 may track and record the hash token in its database and flag for either manual or automatic audit or review any duplicate hash tokens from the same affiliate server 110 within a narrow timeframe. This embodiment permits the detection of duplicate transactions as well as potential fraud or abuse.

It should be appreciated that generated URL 600 may include other fields. In some embodiments, the generated URL 600 may also include information regarding the type of protocol being used (e.g., HTTP or HTTPS), the internet protocol address (i.e., IP address) of affiliate server 110, the affiliate's 110 hostname, the page located at the affiliate server 110 generating the generated URL 600, the page's title, whether the request was a “POST” or a “GET” to the affiliate server 110, and whether the affiliate server 110 was reached by way of a referral. Such addition information may be used for security and fraud detection or prevention as well as for the purposes of auditing and accounting to affiliate server 110.

Network server system 102 may use the generated URL 600 to validate a reward transaction. Given current technology limitations, none of the tokens 608, 610, 612, 614, or 616 can provide perfect security. However, the present invention layers variable types and sources, therefore, providing a powerful deterrent to any potential abuse. First, the unencrypted tokens, such as tokens 608, 610, 612 and 614, are compared with data stored in the reward offer database at network server system 102. For example, when affiliate server 110 created an offer, see decision 306 and boxes 308-316, network server system 102 stored certain information in an offer database. In one embodiment, the information gathered from affiliate server 110 at that time is stored in a record having the affiliate identification number, the action identification number and the affiliate domain information. Accordingly, in this embodiment, the network server system 102 can compare the corresponding values transmitted via the generated URL 600 to determine whether any valid reward action exists. In another embodiment, the network server system 102 may additionally use other values, such referral information, to corroborate information based via the generated URL 600. The referral information may include, for example, the source of the generated URL 600.

Second, network server system 102 can compare the time stamp of the generated URL, token 614, with a time stamp generated by network server system 102 itself. If the time stamps differ by a preset amount of time, network server system 102 may ignore this request. In the typical embodiment, the duration is set sufficiently long so as to account for long delays between the time a reward action occurs at affiliate server 110, the acknowledgement information is returned to member computer 104, and the generated URL is requested by member computer 104. For example, a duration of less than 5 minutes is typical. If the time stamp is within the allocated time, network server system 102 generates its own hash value.

In one embodiment of the present invention, the network server system 102 is programmed to check the time at affiliate system 110 so as to keep accurate account of time for purposes of the time stamp. In this case, the affiliate system 110 may run a script accessible by the network server system 102 that reports the microtime, e.g., time accurate to the microsecond. The network server system 102 then stores the difference, i.e., the offset, between the microtime at the affiliate system 110 and the microtime at the network server system 102. The offset is then used when doing any time based comparisons. An additional advantage of this system is that it can also account for transmission delays and delays in processing time between the network server system 102 and the affiliate system 110. The network server system 102 may check this on a regular basis or on an as-needed or as-required or as-called (i.e., at operator instruction) basis.

Network server system 102 can use the same hash function used by affiliate server 110 in the affiliate code. In the typical embodiment, the hash function takes a secret hash key and the timestamp. The hash key is stored in the offer database in the entry identified by the affiliate identification number and the action identification number. The result of the hash function is then compared to the hash token, token 614, of the generated URL 600. If the values match, the reward action is valid. If the values do not match, the reward action is rejected.

In one embodiment, network server system 102 may perform additional validations. For example, in one embodiment, network server system 102 may also validate that affiliate server 110 has not depleted the point reserves and that it has sufficient points to deposit the points in the member computer 104's points account. In another embodiment, network server system 102 may validate that member computer 104 has not exceeded the allotted number of points available during a specified time period. As described above, network server system 102 permits an affiliate to set a maximum number of points, see block 316 FIG. 3. A similar validation may check to see whether a total number of points across all members has exceeded a preset maximum. In either case, if the maximum number of points has been exceeded, network server system 102 may reject the reward action.

In another embodiment, network server system 102 may log additional details via its web logging system. Such details may include IP addresses of members, referral information, dates, times, and other information typically logged for security and audit purposes. This information may be used to audit and validate reward redemption.

In the typical embodiment, systems 102 and 502 are standard web servers running a server side script. Systems 102 and 502 can utilize standard web server techniques including MOD REWRITE to mask server side script as standard image files. Systems 102 and 502 may be implemented in a distributed manner. In addition systems 102 and 502 may be comprised of one or more web servers masked to appear as a single server. Systems 102 and 502 may also run a database management system directly on the same server, or may access a separate database server. The database system may be a typical relational database or be implemented as any of the many other standard database technologies. In one embodiment, the systems 102 and 502 store member, affiliate, and reward information in a MySQL database.

Systems 102 and 502 can be connected to a network. In the typical embodiment, systems 102 and 502 are connected to the internet or other network via a standard local area network (LAN). In some embodiments, the network connections may use secure networks, WAN, or wireless LAN connections.

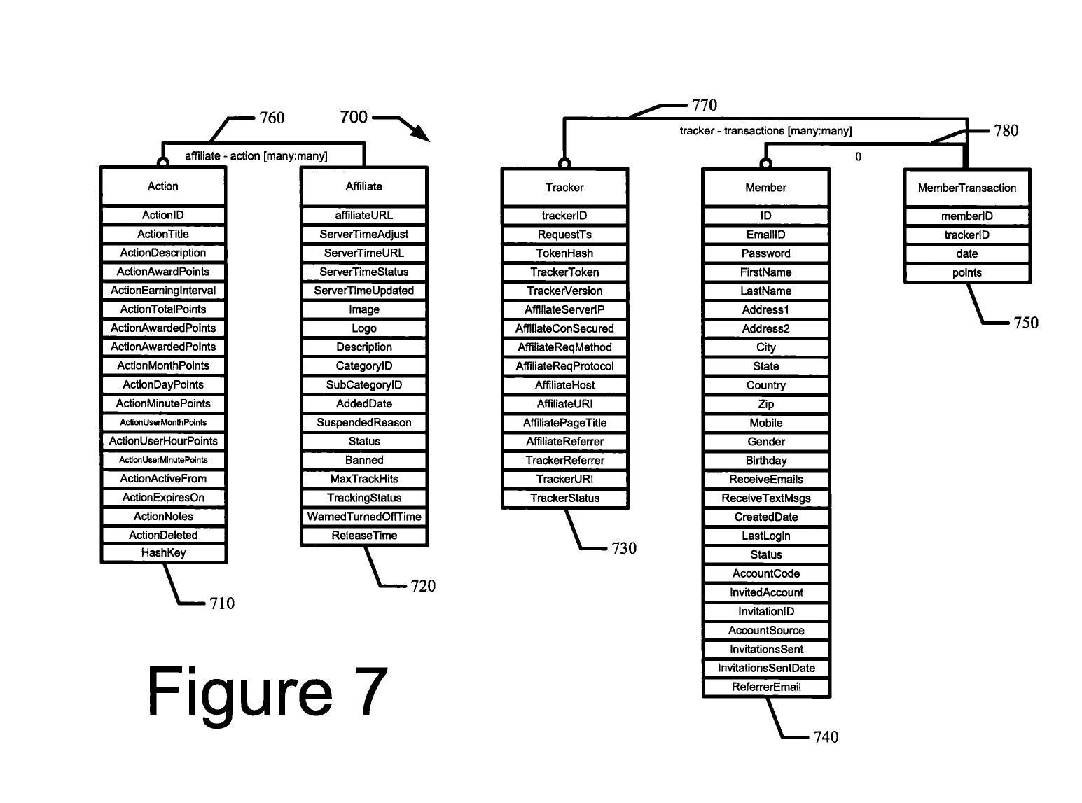

FIG. 7 illustrates at a high level a database schema 700 for storing actions, affiliates and member information. Action table 710 is associated with affiliate table 720. The affiliate table 720 is comprised of one or more affiliate records. The contents of an affiliate record may have values for one or more of the fields shown in affiliate table 720. Each affiliate record can be associated with one or more action records in the action table 710. The action table 710 contains the reward-generating offers specified by an affiliate. The action table 710 further includes the number of points awarded for the action, as well as, the maximum number of points awarded. It will be appreciated that while information significant to any particular action may be stored in part in the action table 710, in part in the affiliate table 720, or in part in other related or associated tables in schema 700, a single record may be formed by selecting the appropriate information from each table. In this sense, an affiliate record may be generated by joining information from both the affiliate table 720 and the action table 710 using customary technologies and strategies known to those of ordinary skill in the art. Additional information in the action table 710 include tracking and reporting information such as the number of points awarded and the occurrence of such points.

The affiliate table 720 includes identifying information for an affiliate. It will be appreciated that such information will vary by implementation. In addition to customary contact information shown, the affiliate table 720 can further include information concerning contract terms, payment method, subscription status, and subscription term. This information may be included directly into the affiliate table 720 or relationally linked (or otherwise associated) with the affiliate table 720.

The member table 740 consists of one or more member records. The each member of the reward system has its own member record in the member table 740. Each member record may have values for some or all of the fields shown in member table 740. Furthermore, it will be appreciated that a member record may comprise information stored in one or more of the tables shown in schema 700. For instance, a member record can be created by a the database management system comprising information from the member table 740 and the sum of all points associated with the member record in the member transaction table 750. As the member performs reward actions, those transactions are stored in a related table, the member transaction table 750. The member transaction table 750 contains the details of a transaction include the date and time of an action and the points awarded. The member transaction table 750 may be further linked or associated with a logging table, tracker table 730 that contains information for the purpose of tracking member transactions. The information in tracker table 730 can be used to audit the system, mine for member and affiliate behaviors, and for other statistical or analytical purposes.

It will be further appreciated that one or more of the tables in schema 700 may be normalized to contain more or fewer fields depending on implementation without detracting from the purpose. Furthermore, it will be appreciated that schema 700 does not show relational tables that associate the tables together. Rather, these relationships are indicated generally by the connecting lines 760, 770 and 780.

In summary, although the system described above is set forth with a certain degree of particularity, it is understood that the present disclosure of embodiments has been made by way of example only and that numerous changes in the arrangement and combination of parts as well as steps may be resorted to by those of skill in the art without departing from the spirit and scope of the present invention.

The invention has been described in connection with what are presently considered to be the most practical and preferred embodiments. However, the present invention has been presented by way of illustration and is not intended to be limited to the disclosed embodiments. Accordingly, those skilled in the art will realize that the invention is intended to encompass all modifications and alternative arrangements within the spirit and scope of the invention as set forth in the appended claims.

The invention claimed is:

1. A rewards network server for use in a rewards system comprising at least one affiliate system and at least one member computer, the rewards network server comprising:
a database system comprising:
at least one member record, the member record comprising a member identification, a date, and a point count; and
at least one affiliate record, the affiliate record comprising an affiliate identification, an action identification, a point count, and an affiliate hash key; and
at least one computer server programmed to:
receive a network request for a resource from the member computer, the network request comprising an affiliate identification token, an action identification token, a time stamp token, and a hash code token;
receive a member identifier from the member computer;
retrieve an affiliate record from the database system associated with the affiliate identification token and the action identification token;
compute a system hash from the affiliate hash key in the affiliate record and the time stamp token; and
compare the system hash to the hash code token, and if the system hash and the hash code token match, add the point count from the affiliate record associated with the affiliate identification token and action identification token to the point count in the member record associated with the member identifier.

2. The rewards network server of claim 1, wherein the database system further comprises at least one affiliate account record, the affiliate account record comprising an affiliate identification and a point balance.

3. The rewards network server of claim 2, the at least one computer server further programmed to, upon adding the point count from the affiliate record to the member record associated with the member identifier, subtract the point count from the point balance associated with the affiliate identification token.

4. The rewards network server of claim 1, wherein the affiliate record further comprises a point maximum, the point maximum is selected from the group consisting of: a maximum number of points that may be awarded in a time period; a maximum number of points that may be awarded to a member computer; and a maximum number of points that may be awarded for an action identification.

5. The rewards network server of claim 1, wherein the action identification is associated with a reward action, the reward action is selected from the group consisting of: a webpage request, a search request, a completion of a commercial transaction, a subscription to a newsletter or mailing list, a purchase of access to premium content, a registration with a website or forum, and a click-through of an advertisement.

6. The rewards network server of claim 5, wherein each reward action is associated with a different point count in the database system.

7. The rewards network server of claim 1, wherein the at least one computer server further programmed to transmit an acknowledgement to the member computer.

8. The rewards network server of claim 7, wherein the acknowledgement is selected from the group consisting of: a display of the points awarded associated with the action token, a display of the point count in the member record associated with the member identifier, and a display of no points award if the system hash and hash code token did not match.

9. The rewards network server of claim 7, wherein the acknowledgement is transmitted as the resource responsive to the network request.

10. The rewards network server of claim 7, wherein the acknowledgement is transparent or not visible to the member.

11. The rewards network server of claim 1, wherein the hash code token is a hash of the time stamp and the affiliate hash key.

12. The rewards network server of claim 11, wherein the affiliate hash key is assigned by the reward system.

13. The rewards network server of claim 11, wherein the hash code expires after a period of time.

14. The rewards network server of claim 13, wherein the period of time is less than one minute.

15. The rewards network server of claim 1, wherein the network request is received as an FTP, HTTP, or HTTPS request.

16. The rewards network server of claim 1, wherein the at least one computer server is further programmed to:
offer the member computer a list of rewards items, wherein each of the rewards items is associated with a value specified in points;
deduct the value specified in points for a selected reward item from the point count in the member record associated with the member identifier upon receipt of selection of the selected rewards item by the member computer; and
transmit an order for the selected rewards item to be shipped to a member associated with the member computer.

17. The rewards network server of claim 16, wherein the list of rewards items is selected from the group consisting of: a tangible good; access to premium or restricted content; a service; and a gift certificate.

18. The rewards network server of claim 16, wherein the list of rewards items includes goods or services from the at least one affiliate system.

19. The rewards network server of claim 16, wherein the list of rewards items includes goods or services from at least one unaffiliated vendor.

20. The rewards network server of claim 16, wherein the at least one computer server is further programmed to accept payment from the member for a selected rewards item and wherein the payment may be in addition to deducting the value specified in points.

21. The rewards network server of claim 1, wherein the at least one computer server is further programmed to charge an affiliate for the point count in the affiliate record; wherein the charge corresponds to the point count multiplied by an exchange rate for money-for-points set by the rewards system.

22. The rewards network server of claim 21, wherein the charge is performed when the associated affiliate record is created.

23. The rewards network server of claim 21, wherein the charge is performed when the associated point count nears zero.

24. The rewards network server of claim 21, wherein the charge is performed upon adding the point count to a member record.

25. The rewards network server of claim 21, wherein the charge is performed at the request of the affiliate system associated with the affiliate record.

26. The rewards network server of claim 21, wherein the charge is a subscription charge and the exchange rate is unlimited points for the subscription charge during a period of time.

27. The rewards network server of claim 1, wherein the network request is a request for an image.

28. The rewards network server of claim 1, wherein the network request is a request for a webpage.

29. The rewards network server of claim 1, wherein the member identifier is received from a cookie stored on the member computer.

30. The rewards network server of claim 29, wherein the at least one computer server is further programmed to store the cookie on the member computer.

31. The rewards network server of claim 1, wherein the at least one affiliate system cannot determine the member identifier associated with a member computer.

32. The rewards network server of claim 1, wherein the at least one affiliate system is not the rewards network server.

33. A method of rewarding an end user in a communications network having a rewards network server and an affiliate server, the method comprising the steps of:
receiving a network request for a resource from an end user computer, the network request comprising an affiliate identification token, an action identification token, a time stamp token, and a hash code token;
receiving a member identification number from the end user computer, the member identification number being associated with the end user in a database system of the rewards network server;
retrieving an affiliate record associated with the affiliate identification token and the action identification token from the database system, the affiliate record comprising an affiliate identification, an action identification, a point count, and an affiliate hash key;
retrieving a member record associated with the member identification number from the database system, the member record comprising a member identification, a date, and a point count;
computing a system hash from the affiliate hash key in the affiliate record and the time stamp token; and
comparing the system hash to the hash code token, and if the system hash and the hash code token match, then adding the point count from the affiliate record to the point count in the member record.

34. The method of claim 33, further comprising the step of subtracting the point count from the affiliate record from a point balance stored in an affiliate account record associated with the affiliate identification token in the database system, the affiliate account record comprising an affiliate identification and a point balance.

35. The method of claim 33, further comprising the step of comparing the point count from the affiliate record to a point maximum, the point maximum is associated with the affiliate record and is selected from the group consisting of: a maximum number of points that may be awarded in a time period; a maximum number of points that may be awarded to a member computer; and a maximum number of points that may be awarded for an action identification.

36. The method of claim 33, wherein the action identification is associated with a reward action, the reward action is selected from the group consisting of: a webpage request, a search request, a completion of a commercial transaction, a subscription to a newsletter or mailing list, a purchase of access to premium content, a registration with a website or forum, and a click-through of an advertisement.

37. The method of claim 36, wherein each reward action is associated with a different point count in the database system.

38. The method of claim 33, further comprising the step of transmitting an acknowledgement to the end user computer.

39. The method of claim 38, wherein the acknowledgement is selected from the group consisting of: a display of the points awarded associated with the action token, a display of the point count in the member record associated with the member identifier, and a display of no points award if the system hash and hash code token did not match.

40. The method of claim 39, wherein the acknowledgement is transmitted as the resource responsive to the network request.

41. The method of claim 40, wherein the acknowledgement is transparent or not visible to the member.

42. The method of claim 33, wherein the hash code token is a hash of the time stamp and the affiliate hash key.

43. The method of claim 42, wherein the affiliate hash key is assigned by the reward network server.

44. The method of claim 42, wherein the hash code expires after a period of time.

45. The method of claim 44, wherein the period of time is less than one minute.

46. The method of claim 33, wherein the network request is a received as an FTP, HTTP, or HTTPS request.

47. The method of claim 33, further comprising the step of charging an affiliate an amount for the point count in the affiliate record; wherein the amount corresponds to the point count multiplied by an exchange rate for money-for-points set by the rewards network server.

48. The method of claim 47, wherein the step of charging is performed when the associated affiliate record is created.

49. The method of claim 47, wherein the step of charging is performed when the associated point count nears zero.

50. The method of claim 47, wherein the step of charging is performed upon adding the point count to a member record.

51. The method of claim 47, wherein the step of charging is performed at the request of the affiliate server associated with the affiliate record.

52. The method of claim 47, wherein the amount is a subscription charge and the exchange rate is unlimited points for the subscription charge during a period of time.

53. The method of claim 33, wherein the resource is an image.

54. The method of claim 33, wherein the resource is a webpage.

55. The method of claim 33, wherein the member identifier is received from a cookie stored on the end user computer.

56. The method of claim 55, further comprising the step of storing the cookie on the end user computer.

57. The method of claim 33, wherein the affiliate server cannot determine the member identifier associated with the end user computer.

58. The method of claim 33, wherein the affiliate server is not the rewards network server.
